(19) United States
(12) Patent Application Publication
(10) Pub. No.: US 2012/0134352 A1
(43) Pub. Date: May 31, 2012

(54) Systems and Methods for Web-Based Push-To-Talk Communications

(75) Inventor: Trinh D. Vu, Ashburn, VA (US)

(73) Assignee: Nextel Communications, Inc., Reston, VA (US)

(21) Appl. No.: 12/956,014

(22) Filed: Nov. 30, 2010

(51) Int. Cl. H04B 7/212; H04B 7/00

(52) U.S. Cl. 370/347; 455/518

(57) ABSTRACT

A method of enabling a push-to-talk (PTT) connection between a first user on a first network and a second user on a second network is provided. According to the method, a web application registration server on the first network receives and authenticates login information from the first user, forwards the login information to a PTT server, and assigns a temporary network identity from a pre-allocated pool of network identities to a client of the first user. After the PTT registration has been authenticated, a PTT call may be conducted between the first user and the second user. The first network may be an internet protocol-based network. The second network is a multiple-access network for cellular devices, such as a Time Division Multiple Access (TDMA) network or any other wireless network.

### BACKGROUND OF THE INVENTION

Wireless communication networks typically provide a number of different services, such as voice and data communication services. Most wireless communication networks offer a single type of voice communication services known as interconnect voice communication services (also referred to as circuit-switched voice communication services). Interconnect voice calls typically utilize full-duplex communications, and allow parties participating in the call to listen and talk simultaneously. Interconnect voice calls require setting up a connection between the parties prior to beginning communications, and accordingly do not allow for casual communications to be sent to other parties on the network without first dialing up the parties.

Another type of voice communication services is push-to-talk (PTT) voice communication services (also referred to as dispatch or walkie-talkie communication services). Like a walkie-talkie, PTT calls utilize half-duplex communication between parties. PTT calls require floor control to ensure that only one party has permission to talk at any particular time during the call. For example, Sprint Nextel Corporation's Direct Connect® service provides PTT communications supported on the Integrated Digital Enhanced Network (iDEN®), which is a Time Division Multiple Access (TDMA) network. PTT communication services have also been employed in private wireless communication networks, such as those deployed by taxi cab companies or emergency service agencies (e.g. police and fire departments).

PTT services such as Direct Connect® can support PTT communications between a pair of users (i.e., a private call) and PTT communications among a group of users (i.e., a group call). A PTT device is identifiable in a PTT network by a PTT network address, such as a Universal Fleet Member Identifier (UFMI) associated with the iDEN® network. In order to make or receive a PTT call to and from the iDEN® network, a device must be assigned a UFMI.

In addition to mobile devices, desktop dispatch clients have been developed that allow a user to establish a PTT connection over the Internet via a personal computer using a dedicated application executed on the computer. However, existing desktop dispatch clients have several disadvantages. For example, a permanent network ID, such as a UFMI that enables PTT connections, must be assigned to each desktop dispatch client. There is a substantial cost associated with providing and managing each UFMI on the network, such that it is costly to assign a permanent UFMI to many desktop dispatch clients. Also, the need for a permanent UFMI inhibits casual users from making PTT calls from their personal computers. In addition, desktop dispatch clients reside on a specific personal computer, and cannot be accessed from other devices. Therefore, the user is limited to making and receiving PTT calls from a single computer. Moreover, the dedicated application is written for a specific operating system, and can only be used on computers running the specific operating system (e.g. Windows or Mac OS).

### SUMMARY OF THE INVENTION

According to an aspect of the invention, there is provided a method of enabling a PTT connection between a first user on a first network and a second user on a second network. According to the method, a web application registration server on the first network receives and authenticates login information from the first user, forwards the login information to a PTT application server, and assigns a temporary network identity from a pre-allocated pool of network identities to a client of the first user. The second network is a multiple-access network for cellular devices.

The temporary network identity may be valid only during a registered PTT session that begins with the assigning of the temporary network identity by the web application registration server. The PTT registration session may expire if the registered PTT session is inactive for a predetermined duration. Alternatively, the PTT registration session may expire if the first user logs out of the client and a registration timer expires. If the registered PTT session expires, the temporary network identity may be returned to the pool of network identities that is managed by the web application registration server. The temporary network identity may be a UFMI or any valid PTT identifier.

The login information may include a user name and a password. The login information may be received from the first user via the client on a website that hosts the web application registration server. Alternatively, the login information may be received from the first user via a desktop PTT client.

The first network may be an Internet protocol-based network. The second network may be a TDMA network. The web application registration server may also receive a permanent network identity from the provisioning server after assigning the temporary network identify to the client of the first user.

According to another aspect of the invention, there is provided a method of conducting a PTT call between a first user on a first network and a second user on a second network. Before initiating the call, the first user logs into a client that registers with a web application registration server on the first network, and a temporary network identify is assigned to the client by the web application registration server. According to the method, a PTT connection is established between the first user and the second user when the first user successfully initiates a call. For example, the first user may select the second user's address from the address book or the recent calls list, or manually enter the second user's address. After a predetermined length of time, it is determined whether the temporary network identity remains valid. If the temporary network identity has become invalid, the PTT registration is disabled.

The temporary network identity may be valid only during a registered PTT session that begins with the assignment of the temporary network identity to the client by the web application registration server. The registered PTT session may expire if the client is inactive for a predetermined duration and a registration timer expires. Alternatively, the registered PTT session may expire if the first user logs out of the PTT client and a registration timer expires. If the registered PTT session expires, the temporary network identity may be returned to a pool of network identities that is managed by the web application registration server. For example, the temporary network identity may be a UFMI, a Mobile Directory Number (MDN), a Session Initiation Protocol (SIP) address, or any other PTT identity.

The first network may be an Internet protocol-based network. The second network may be a TDMA network or any other digital network.

Other objects, advantages, and novel features of the present invention will become apparent from the following detailed description of the invention when considered in conjunction with the accompanying drawings.

### BRIEF DESCRIPTION OF THE DRAWINGS

FIG. 1 shows the architecture of a network in accordance with an exemplary embodiment of the present invention;

FIG. 2 shows the call flow to register a web PTT user in accordance with an exemplary embodiment of the present invention; and

FIG. 3 shows the call flow to establish and conduct a PTT call in accordance with an exemplary embodiment of the present invention.

### DETAILED DESCRIPTION OF EXEMPLARY EMBODIMENTS

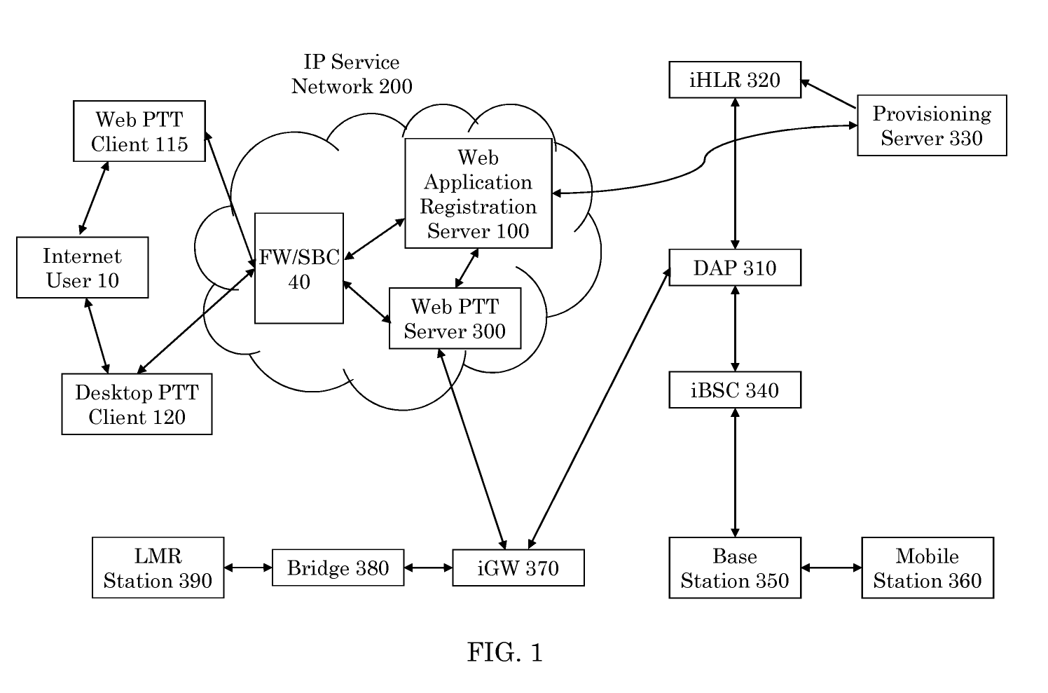

FIG. 1 shows the architecture of a network in accordance with an exemplary embodiment of the present invention. For example, a PTT connection may be enabled between a web PTT client 115 through the web PTT server 300 on an Internet Protocol (IP) service network 200 and a mobile station 360 on an iDEN® network. A number of web application registration servers 100 and web PTT servers 300 may be deployed to interface with a number of web PTT clients 115 or desktop PTT clients 120. The web PTT client 115 resides on a host website, and an Internet user 10 can access the web PTT client 115 through the host website via a standard Internet browser like Internet Explorer. For example, a social networking website such as Facebook® or MySpace® may host the web PTT client 115, and the Internet user 10 can run the web PTT client 115 by clicking the appropriate icon on the host website. An Internet user 10 can advantageously access the web PTT client 115 from an Internet browser on any device and any network that can access web service on the IP service network 200, such as a desktop computer, a laptop computer, and a wireless handheld device. The desktop PTT client 120 resides on a host computer, and the Internet user 10 can run the desktop PTT client 120 by clicking the appropriate application icon on the desktop of the host computer.

As shown in FIG. 1, the web PTT client 115 and the desktop PTT client 120 access the web PTT service via the IP service network 200. The IP service network 200 includes the Firewall/Session Border Controller (FW/SBC) 40, the web application registration server 100, and the web PTT server 300. The FW/SBC 40 provides secured communications to the web application registration server 100 and the web PTT server 300 from the public Internet for the web PTT clients 115 and desktop PTT clients 120. The web application registration server 100 provides registration service to web PTT clients 115 and desktop PTT clients 120, and informs the web PTT server 300 of the active client registrations. The web PTT server 300 is connected to the iDEN® public wireless network to provide interoperability to iDEN® users via the iDEN® gateway (iGW) 370, which is connected to an iDEN® dispatch application processor (DAP) 310, or any other gateway that supports a similar interface. An iDEN® home location register (iHLR) 320 stores a database with a list of authorized users, and is connected to a provisioning server 330 that provisions users and services on the iDEN® network. As discussed below, the provisioning server 330 also provides the bulk provisioning of the temporary UFMIs to the web application registration server 100 for later assignment during service registration. The iDEN® DAP 310 provides call control and routing functions for PTT calls to and from iDEN® users. An iDEN® base station controller (iBSC) 340 controls a base station 350, which provides iDEN® network services to a mobile station 360.

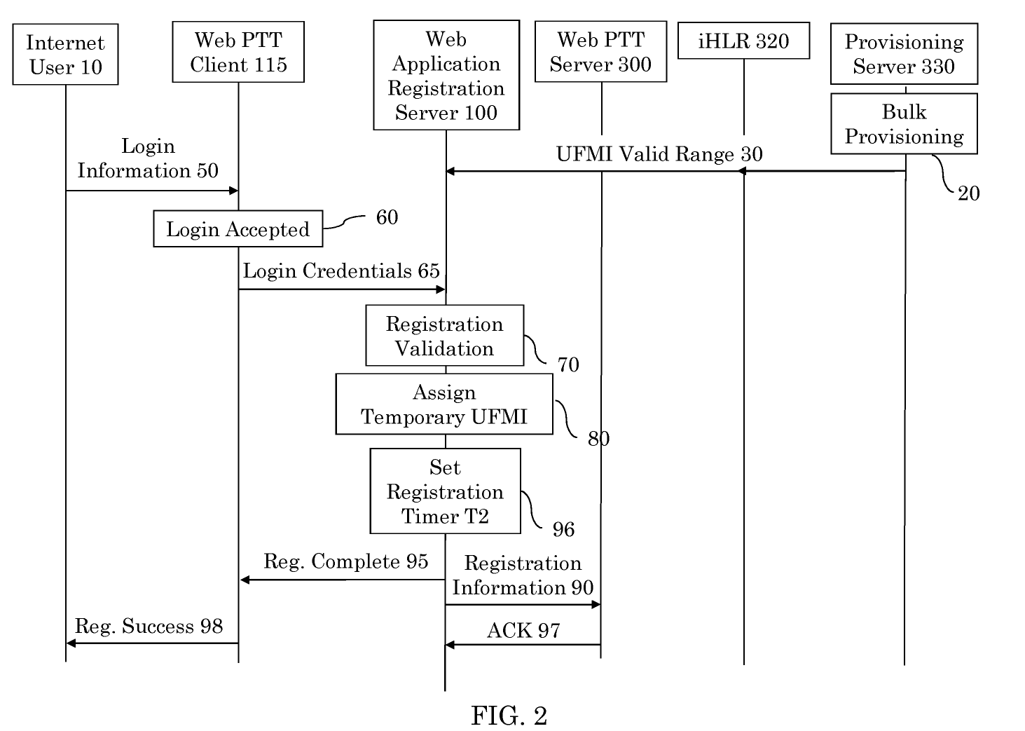

FIG. 2 shows the call flow to enable a web PTT client 115 to register for a PTT connection in accordance with an exemplary embodiment of the present invention. A similar call flow may be used to enable a desktop PTT client 120 to register for a PTT connection. Initially the provisioning server 330 provisions temporary UFMIs in bulk at 20 and sends messages 30 including the valid range of UFMIs to the iHLR 320 and the web application registration server 100. As explained below, when a client is registered, a temporary UFMI within the valid range is assigned from the pool, and is then later reclaimed when the client is either deregistered or timed out. The bulk provisioning of the iHLR 320 and web application registration server 100 are performed before any Internet user 10 attempts to register for the web PTT service.

As shown in FIG. 2, an Internet user 10 sends a message 50 with login information to the web PTT client 115. The login information may include a user name and a password. As discussed above, the web application registration server 100 is the primary contact for the service registration from the web PTT client 115 or the desktop PTT client 120. If the login information is accepted by the web PTT client 115 at 60, the web application registration server 100 receives a message 65 with the login credentials from the web PTT client 115, validates the service registration at 70, and assigns a temporary network ID (UFMI) to the web PTT client 115 at 80. In addition, the web application registration server 100 sets a registration timer T2 at 96 for the expiration of the registration of the web PTT client 115 and its temporary UFMI.

Once the registration is complete, the web application registration server 100 issues a message 95 to the web PTT client 115 to confirm that the service registration is complete. The message 95 includes the temporary UFMI and the registration timer T2. The web application registration server 100 also sends a message 90 with a copy of the service registration information to the web PTT server 300, which responds with a message 97 acknowledging the service registration. The web application registration server 100 then waits for the web PTT client 115 to re-register before the registration timer T2 expires. If the web application registration server 100 does not receive a re-registration message from the web PTT client 115 before the registration timer T2 expires, the web application registration server 100 will delete the registration, reclaim the temporary UFMI, and inform the web PTT server 300 of the expired registration status of the web PTT client 115. If the web application registration server 100 receives a re-registration for the same web PTT client 115 before the registration timer T2 expires, the web application registration server 100 updates the registration database, resets the registration timer T2, and informs the web PTT server 300 of the updated registration status.

Once the web PTT client 115 receives a confirmation message from the web application registration server 100 that the registration is complete, the web PTT client 115 obtains the address of the web PTT server 300, the assigned temporary UFMI, and the registration timer T2. The web PTT client 115 will keep track of two timers: an activity timer and the registration timer T2. The activity timer is user-selectable, and allows the Internet user 10 to log back into the web PTT client 115 before the registration timer T2 expires to activate the session again. If the Internet user 10 does not utilize the web PTT client 115 before the activity timer expires, the web PTT client 115 will automatically log out the Internet user 10 until the Internet user 10 logs back in. However, the web PTT client 115 does not deregister the web PTT client 115 until the registration timer T2 expires. The registration timer T2 will expire if the Internet user 10 is not logged in and the web PTT client 115 does not re-register with the web application registration server 100. If the Internet user 10 is logged in to the web PTT client 115 and the registration timer T2 expires, the Internet user 10 may be prompted to continue the session and the web PTT client 115 may re-register on behalf of the Internet user 10. A similar process will apply for the desktop PTT client 120 regarding user login, but the activity timer and the registration timer T2 timer can be different for the desktop PTT client 120.

Both the web PTT client 115 and the desktop PTT client 120 access the web PTT server 300 for PTT services. The web application registration server 100 may provide many of the address book functions of the Direct Connect® service, such as accessing an online contacts list and a group list. The web PTT server 300 provides many of the functions of the Direct Connect® service, such as initiating Call Alerts, PTT calls, and group calls. The web PTT client 115 and desktop PTT client 120 may provide multiple dialog boxes that include a contact list, a call history list, a call origination/reception dialog including a PTT button for call initiation, a Call Alert mechanism, and buttons for ringer volume, speaker volume, and muting. The default window for the web PTT client 115 or desktop PTT client 120 may be the contacts list or the call history list, and mapped keyboard keys may be designated to operate specific functions. Individual icons may be used to designate call types, such as Direct Call, Group Call, and Call Alert. Users of the web PTT client 115 and the desktop PTT client 120 can also communicate via PTT dialogs with each other in accordance with exemplary embodiments of the present invention.

Before a PTT session, the presence status of the Internet user 10 may be designated as Available, Not Available, Busy On A Call, or Do Not Disturb. The Internet user 10 may designate his status as Do Not Disturb. The other status designations are automatically assigned based on the status of the Internet user 10. Icons may be used to designate the presence status of other web PTT clients 115.

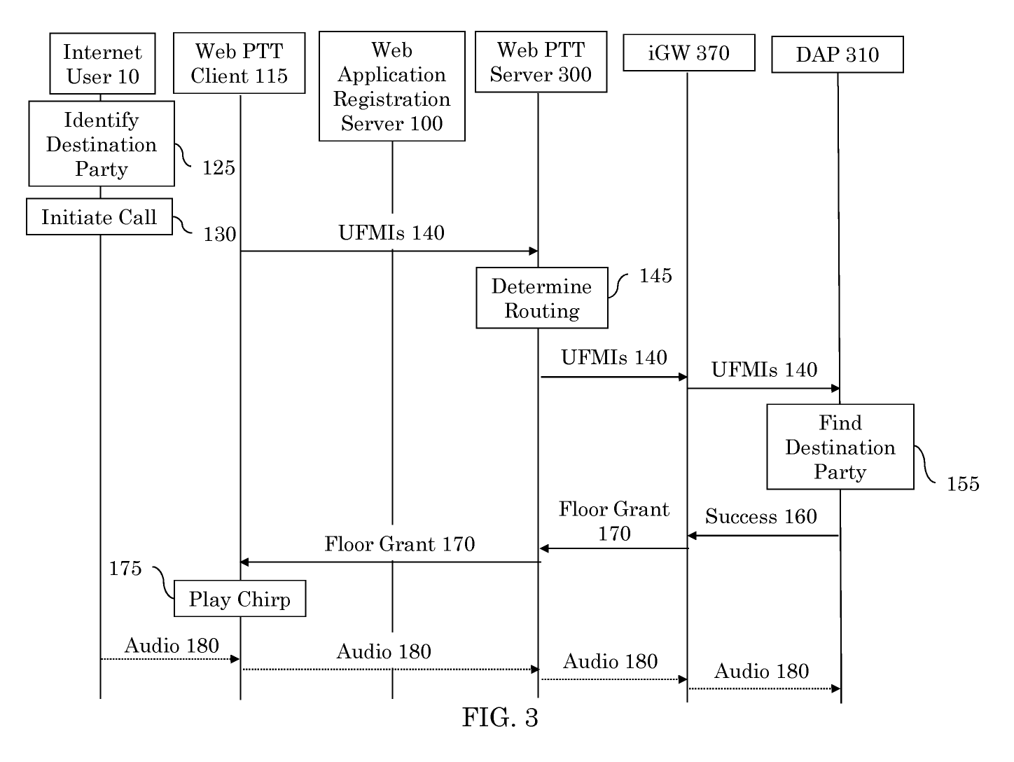

FIG. 3 shows a method of establishing and conducting a PTT call in accordance with an exemplary embodiment of the present invention. The method shown in FIG. 3 begins after the registration of the web PTT client 115 with the web application registration server 100 has been completed successfully and the temporary UFMI has been assigned to the web PTT client 115, as discussed with reference to FIG. 2.

As shown in FIG. 3, the Internet user 10 first identifies the destination party with whom the Internet user 10 would like to communicate at 125. The Internet user 10 may identify the destination party by selecting a contact from the contacts list or the recent calls list, or by manually entering the UFMI of the destination party into the web PTT client 115. The Internet user 10 may then initiate a PTT call at 130 by depressing the PTT button for call initiation from the call dialog box of the web PTT client 115. The PTT connection is established according to standard PTT procedures and communications between the Internet user 10 and the destination party, such as the mobile station 360.

Specifically, the web PTT client 115 sends a call message 140 to the web PTT server 300 that includes the UFMIs of the web PTT client 115 and the destination party. The web PTT server 300 determines routing to the destination party at 145 and routes the call to the iDEN GW 370. The iDEN GW 370 then sends a call request to the DAP 310, which in turn pages and finds the destination party (i.e. the mobile station 360) at 155. The DAP 310 returns a call success message 160 to the iDEN GW 370, which in turn sends a floor grant message 170 to the web PTT server 300. The web PTT server 300 sends the floor grant message 170 to the web PTT client 115 and sets up a voice path to the iDEN GW 370. The web PTT client 115 then provides a “chirp” tone to the Internet user 10 at 175, signaling that the PTT call has been successfully set up and the Internet user 10 can begin speaking. Once the PTT call has been established, the dialog box at the web PTT client 115 may identify all PTT participants, including the Talker, and indicate when the floor is open and when the PTT call has ended. When the Internet user 10 speaks, the audio will be captured by the web PTT client 115 and a message 180 with the audio will be sent to the mobile station 360 via the web PTT server 300 along the speech path.

The Internet user 10 may terminate the PTT call by closing the dialog box or by depressing the End key within the dialog box. Further, if the PTT call is inactive for a predetermined length of time, such as six seconds, a hang timer at the web PTT server 300 will terminate the PTT connection between the users. The Internet user 10 may reestablish the PTT connection by pressing the PTT button from the address book or call history list as long as the registration remains valid. The Internet user 10 may be notified of the need to log into the web PTT client 115 again in order to maintain the web PTT registration. Alternatively, the registration information may be sent automatically to the web application registration server 100 upon any action by the Internet user 10, such as an automatic login. In this case, the Internet user 10 may or may not be notified that an additional login was performed.

In exemplary embodiments of the present invention, a PTT connection begins with the successful login of the Internet user 10 to the web PTT client 115, which in turn registers for PTT service with the web application registration server 100. The completed registration will cause the assignment of the temporary UFMI that remains valid during the PTT registration timer T2, allowing the Internet user 10 to originate PTT calls via the web PTT server 300 and to receive calls from any device or client that knows the temporary UFMI assigned to the web PTT client 115. For example, if the Internet user 10 logs into the web PTT client 115, registers with the web application registration server 100, and initiates a call to the mobile station 360, the web PTT server 300 will identify the Internet user 10 by the temporary UFMI. The mobile station 360 can then return the call by selecting the temporary UFMI from the call history list, as long as the temporary UFMI remains valid (i.e. the registration remains valid).

However, once the temporary UFMI assigned to the web PTT client 115 becomes invalid, the temporary UFMI can no longer be used to enable a PTT connection with the Internet user 10. The temporary UFMI becomes invalid when the PTT registration session is terminated by the registration timer T2. The registration timer T2 allows the temporary UFMI to remain valid only for a predetermined length of time after the web PTT client login session has become inactive, as indicated by the expiration of the activity timer. For example, the expiration of the registration timer T2 may cause the temporary UFMI to become invalid if the web PTT client 115 does not re-register before then. The activity timer may be set in advance for the web PTT client 115 to ensure that the Internet user 10 is timed out, and the web PTT client 115 will only have to re-register before the expiration of the registration timer T2 if the user 10 is actively logged in. In addition, the temporary UFMI may become invalid when the Internet user 10 logs out of the web PTT client 115 or desktop PTT client 120 and the registration timer T2 expires. However, the mere termination of a PTT connection by the hang timer described above does not invalidate the temporary UFMI until the registration timer T2 expires at the web PTT client 115 or desktop PTT client 120.

As discussed above, once the temporary UFMI becomes invalid, the Internet user 10 can no longer use the temporary UFMI to enable a PTT connection. Instead, if the Internet user 10 wishes to enable a new PTT connection, the Internet user 10 will be required to again log into the web PTT client 115 or desktop PTT client 120, which in turn registers with the web application registration server 100 again in order to obtain a new temporary UFMI, in accordance with the method shown in FIG. 2. The Internet user 10 may be notified of the need to log into the web PTT client 115 or desktop PTT client 120 again to obtain a new temporary UFMI. Alternatively, before the expiration of the registration timer T2, the login information may be resent automatically to the web application registration server 100 upon a relogin action by the Internet user 10 at the web PTT client 115 or desktop PTT client 120. In this case, the Internet user 10 may or may not be notified that an additional login was performed, depending on the setting at the web PTT client 115 or desktop PTT client 120.

Once the temporary UFMI becomes invalid, the temporary UFMI is returned to a pre-allocated pool of UFMIs and may be recycled to enable another web PTT registration at the web application registration server 100. Using temporary UFMIs reduces the cost of providing PTT service to many users, because many web PTT users can be accommodated with a smaller pre-allocated pool of UFMIs. For example, a pool including several hundred thousand temporary UFMIs can be used to enable PTT connections for several million users at various times, thereby reducing the cost in comparison with a system that uses only permanent UFMIs. Another advantage of using a temporary pool of network IDs is that the web PTT users can obtain PTT service via self-registration, and do not need to rely on the network providers to provision them into the web application registration server 100, unlike a desktop client with a permanent network ID.

However, if the Internet user 10 prefers to have a dedicated UFMI, a permanent UFMI may be assigned to the Internet user 10 via the web application registration server 100. The Internet user 10 may request a permanent UFMI after a temporary UFMI has been assigned by the web application registration server 100 with an appropriate billing agreement. Once a permanent UFMI has been assigned, the web PTT client 115 or desktop PTT client 120 can make and receive PTT calls at any time, and no temporary UFMI reassignment will be necessary. The web PTT client 115 or desktop PTT client 120 will longer receive temporary UFMIs from the web application registration server 100 and can cache the permanent UFMI. Along with managing the pool of UFMIs, the web application registration server 100 determines whether a web PTT client 115 or desktop PTT client 120 has been assigned a temporary UFMI or a permanent UFMI, and provides the appropriate services to these clients.

The web PTT server 300 may also provide interoperability between the Internet user 10 and a private wireless communication network, such as a land mobile radio (LMR) network. As shown in FIG. 1, an iDEN gateway iGW 370 and a bridge 380, such as a Motobridge®, could be used to establish communications between a user using the web PTT server 300 and an LMR station 390. Accordingly, a PTT connection could be enabled between the web PTT client 115 or the desktop PTT client 120 and users of the LMR network.

In addition, the web PTT client 115 and the desktop PTT client 120 may support an open Application Programming Interface (API) via a Software Development Kit (SDK). The web PTT client 115 may be embeddable in other web applications to support PTT calls to and from iDEN® users. The desktop PTT client 120 may be embeddable in other desktop applications like an Office suite to support PTT calls to and from iDEN® users in addition to the normal office functions.

Although exemplary embodiments have been described in connection with iDEN® as the radio access network, the present invention can employ any type of radio access network. For example, the radio access network can be a Code Division Multiple Access (CDMA) network or High Speed Packet Access (HSPA) network that supports PTT over Cellular (POC). In this case the call identifier would be a Mobile Directory Number or a Session Initiation Protocol (SIP) address instead of a UFMI.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of enabling a push-to-talk (PTT) connection between a first user on a first network and a second user on a second network, the method comprising the acts of:
receiving and authenticating, by a web application registration server on the first network, login information from the first user;
forwarding, by the web application registration server, the login information to a PTT server; and
assigning, by the web application registration server, a temporary network identity from a pre-allocated pool of network identities to a client of the first user,
wherein the second network is a multiple-access network for cellular devices.

2. The method according to claim 1, wherein the temporary network identity is valid only during a registered PTT session that begins with the assigning of the temporary network identity by the web application registration server.

3. The method according to claim 2, wherein the registered PTT registration session expires if the registered PTT session is inactive for a predetermined duration.

4. The method according to claim 2, wherein the registered PTT session expires if the first user logs out of the client and a registration timer expires.

5. The method according to claim 2, wherein if the registered PTT session expires, the temporary network identity is returned to the pool of network identities that is managed by the web application registration server.

6. The method according to claim 1, wherein the temporary network identity is an urban fleet member identifier (UFMI).

7. The method according to claim 1, wherein the login information comprises a user name and a password.

8. The method according to claim 1, wherein the login information is received from the first user via the client on a website that hosts the web application registration server.

9. The method according to claim 1, wherein the login information is received from the first user via a desktop PTT client.

10. The method according to claim 1, wherein the first network is an Internet protocol-based network.

11. The method according to claim 1, wherein the second network is a Time Division Multiple Access (TDMA) network.

12. The method according to claim 1, further comprising the act of:
receiving, by the web application registration server, a permanent network identity, after assigning the temporary network identity to the client of the first user.

13. A method of conducting a push-to-talk (PTT) call between a first user on a first network and a second user on a second network, wherein the first user has logged into a client that registers with a web application registration server on the first network and a temporary network identity has been assigned to the client by the web application registration server, the method comprising the acts of:
establishing a PTT connection between the first user and the second user;
after a predetermined length of time, determining whether the temporary network identity remains valid; and
if the temporary network identity has become invalid, disabling the PTT registration.

14. The method according to claim 13, wherein the temporary network identity is valid only during a registered PTT session that begins with the assignment of the temporary network identity to the client by the web application registration server.

15. The method according to claim 14, wherein the registered PTT session expires if the client is inactive for a predetermined duration and a registration timer expires.

16. The method according to claim 14, wherein the registered PTT registration session expires if the first user logs out of the client and a registration timer expires.

17. The method according to claim 14, wherein if the registered PTT registration session expires, the temporary network identity is returned to a pool of network identities that is managed by the web application registration server.

18. The method according to claim 13, wherein the temporary network identity is an urban fleet member identifier (UFMI) or a Mobile Directory Number (MDN) or a Session Initiation Protocol (SIP) address.

19. The method according to claim 13, wherein the first network is an Internet protocol-based network.

20. The method according to claim 13, wherein the second network is a Time Division Multiple Access (TDMA) network.
